(19) United States
(12) Patent Application Publication
(10) Pub. No.: US 2012/0089691 A1
(43) Pub. Date: Apr. 12, 2012

(54) UNIDENTIFIED RECIPIENTS MESSAGE EXCHANGE SERVICE PROVIDING METHOD

(76) Inventor: Yong Han KIM, Seoul (KR)

(21) Appl. No.: 13/310,527

(22) Filed: Dec. 2, 2011

(30) Foreign Application Priority Data
Sep. 30, 2010 (KR) 10-2010-0095331
Apr. 27, 2011 (KR) 10-2011-0039617

(51) Int. Cl. G06F 15/16

(52) U.S. Cl. 709/206

(57) ABSTRACT

An unidentified recipients message exchange service providing method includes, by a service providing server for providing the method, receiving a target set from a first user terminal; receiving a filter set from a second user terminal; receiving a message from the first user terminal; selecting second user terminals to receive the message using contents of the received message, the target and the filter; and sending the message as an anonymous message if desired to the selected second user terminals. Accordingly, it is possible to allow a recipient to receive only desired messages sent through a filter without the sender specifying the recipient so that the message can reach wider audience by the server receiving a target and a filter, set by users, and a message inputted from the user and sending the message to the selected users using contents of the received message, the target, and the filter.

### CROSS-REFERENCE TO RELATED APPLICATION

This application claims the benefit of Korean Patent Application No. 10-2010-0095331, filed Sep. 30, 2010, the disclosure of which is hereby incorporated herein by reference in its entirety.

### BACKGROUND OF THE INVENTION

1. Field of the Invention

An aspect of the present invention relates to a message exchange service providing method, and more particularly, to an unidentified recipients message exchange service providing method.

2. Description of the Related Art

With the rapid development of the Internet and mobile terminals, methods for exchanging various messages through networks are commonly used, including e-mail, short message service (SMS), multi message service (MMS), and the like. In a conventional message exchange service such as e-mail, SMS or MMS, a message can be sent when a person intended to receive the message is exactly identified, although a person receiving a message typically does not receive only desired messages. Therefore, the reception of unnecessary messages is a serious problem. Further, since a sender or receiver's personal information such as an e-mail address, phone number, etc. is made available, protection of personal information is not well fulfilled.

Meanwhile, a social network service (SNS) through which a person can have relations with other people online is commonly used today. The SNS refers to a service that enables a person to reinforce existing personal connections with acquaintances on the Web, to acquire new personal connections and to form a wide human network. As the desire for personal expression has increased, the SNS that allows a person to have social relations with other people and to maintain friendships has developed. In community services such as a cafe on the Web and an association, a group having a common interest in a specific subject shares an exclusive service. On the other hand, in the SNS, an individual as a central figure shares his/her own interests and individual characteristics with other people. Cyworld, Twitter, Facebook, Myspace, etc. are representative of the SNS.

In a conventional message exchange service such as the SNS, a message can be sent to many people. However, specific people must be added as friends, associates etc. to receive the sent message. Since the message is not frequently classified by subject, tag or the like, there is a limitation that a person receiving the message is unnecessarily exposed to excess information. Further, since the conventional message exchange service such as the SNS deals with a person's private life, it is difficult to exchange business information. Furthermore, since personal information such as an individual's name, ID, photograph, contact address, etc. are available without filtering, the personal information is excessively exposed.

### SUMMARY OF THE INVENTION

Embodiments of the present invention provide an unidentified recipients message exchange service providing method that enables a recipient to receive only desired messages sent through a filter without the sender specifying the recipient so that the message can reach wider audience, by the server receiving a target and a filter, set by the user, and a message inputted by the user and sending the message using contents of the received message, the target and the filter.

Embodiments of the present invention also provide an unidentified recipients message exchange service providing method capable of protecting personal information by sending a message as an anonymous message, and, if necessary, supporting smooth communication by sending a message as a real-name message under a mutual agreement between users.

According to an aspect of the present invention, there is provided an unidentified recipients message exchange service providing method, including the steps of: by a service providing server for providing the method, (1) receiving a target set from a first user terminal; (2) receiving a filter set from a second user terminal; (3) receiving a message from the first user terminal; (4) selecting second user terminals to receive the message using contents of the received message, the target and the filter; and (5) sending the message to the selected second user terminals, wherein the method further comprises a step of receiving whether or not to send the message as an anonymous message, selected from the first user terminal, and when receiving the selection of sending the message as an anonymous message from the first user terminal, the service providing server sends the message as an anonymous message to the selected second user terminal at step (5).

The method may further include a step of (0) receiving user information from the first and second user terminals so as to generate accounts by the service providing server.

At step (0), the user information may be encrypted and stored.

The target or filter may be selected from a tag group containing a plurality of tags.

The tag group may contain a public tag defined by the service providing server and a private tag defined by the first user terminal.

The message may contain a message type, an essential content, a selective content, and keywords.

The method may further include a step of (6) receiving a reply message inputted from the second user terminal and sending the received reply message to the first user terminal.

The method may further include a step of (7) sending the message as a real-name message under a mutual agreement between first and second users.

Step (7) may include the steps of: receiving a request for the message as the real-name message from the first or second user terminal; sending the received request to the second or first user terminal; receiving an approval for the sent request from the second or first user terminal; and sending the message as the real-name message to the second user terminal.

Each of the first and second user terminals may be a smart device in which an application program for implementing the method is installed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a configuration of a system for implementing an unidentified recipients message exchange service providing method according to an embodiment of the present invention;

FIG. 2 is a flowchart illustrating the unidentified recipients message exchange service providing method according to an embodiment of the present invention;

FIG. 3 is a view showing first or second user terminal having a setup screen displayed thereon in the unidentified recipients message exchange service providing method according to an embodiment of the present invention;

FIG. 4 is a view showing the first user terminal at which a message is inputted at step S400 in the unidentified recipients message exchange service providing method according to an embodiment of the present invention;

FIG. 5 is a view showing the second user terminal receiving a message sent at step S600 in the unidentified recipients message exchange service providing method according to an embodiment of the present invention; and

FIG. 6 is a flowchart illustrating a detailed procedure at step S800 in the unidentified recipients message exchange service providing method according to an embodiment of the present invention.

### DETAILED DESCRIPTION OF THE INVENTION

The present invention is described more fully hereinafter with reference to the accompanying drawings, in which embodiments of the present invention are shown. This present invention may, however, be embodied in many different forms and should not be construed as limited to the embodiments set forth herein. Rather, these embodiments are provided so that this disclosure is thorough, and will fully convey the scope of the present invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

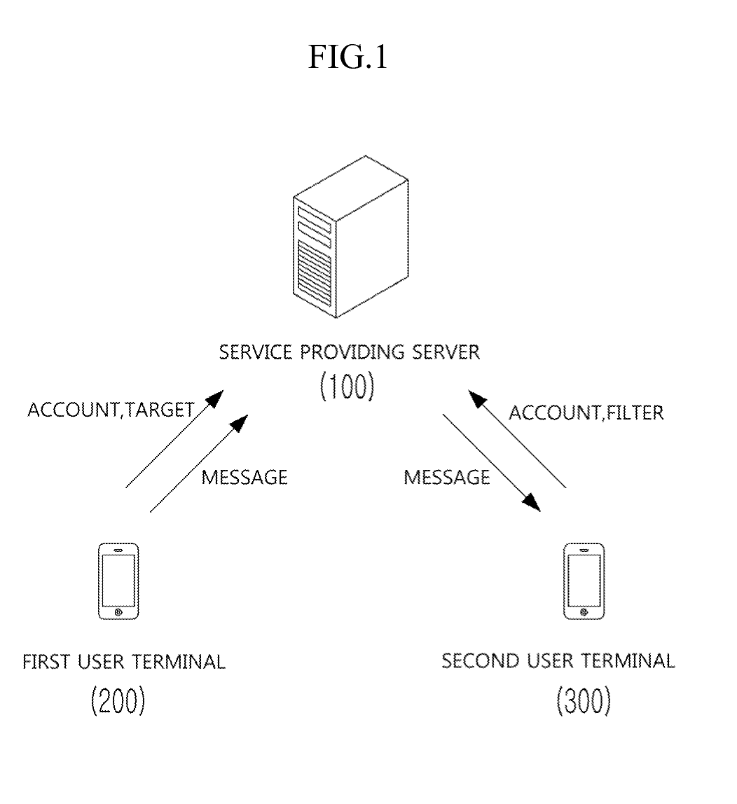

FIG. 1 is a view showing a configuration of a system for implementing an unidentified recipients message exchange service providing method according to an embodiment of the present invention. As shown in FIG. 1, the system for implementing the unidentified recipients message exchange service providing method according to this embodiment may include a service providing server 100, a first user terminal 200 of a first user and a second user terminal 300 of a second user.

That is, in the unidentified recipients message exchange service providing method according to this embodiment, the service providing server 100 receives user information inputted from the first and second user terminals 200 and 300 and generates accounts. The service providing server 100 may receive a target set by the first user to be used for sending messages from the first user terminal 200, and may receive a filter set by the second user to be used for receiving messages from the second user terminal 300. If the first user terminal 200 sends a message to the service providing server 100, the service providing server 100 selects the second user terminal 300 to receive the message with reference to the target, the filter and contents of the message, and sends the message to the selected second user terminal 300. In the unidentified recipients message exchange service providing method according to this embodiment, the first user of the first user terminal 200 who sends the message, and the second user of the second user terminal 300 who receives the message, cannot know information of each other at all. The first and second users can exchange messages with each other without directly searching for each other or adding each other as a friend. Since the service providing server 100 can send the message as an anonymous message, anonymity can be secured, thereby preventing exposure of personal information. Hereinafter, each of the components in the system for implementing the unidentified recipients message exchange service providing method according to this embodiment will be described in detail.

The service providing server 100 is a server for implementing the unidentified recipients message exchange service providing method according to this embodiment. The service providing server 100 may allow access by the first and second user terminals 200 and 300, store user information of the first and second users, store a target set by the first user and a filter set by the second user, and manage various kinds of tag groups. The service providing server 100 may send the message sent from the first user terminal 200 as an anonymous message, thereby ensuring anonymity in message exchange.

The first user terminal 200 is a user terminal for sending a message using the unidentified recipients message exchange service providing method according to this embodiment. The second user terminal 300 is a user terminal that receives a message sent from the first user terminal 200 using the unidentified recipients message exchange service providing method according to this embodiment. That is, the first and second user terminals 200 and 300 are used to distinguish between a sender and a recipient in the present invention. However, one user terminal may serve as first and second user terminals 200 and 300 at the same time.

Each of the first and second user terminals 200 and 300 may be a computer, notebook computer, portable computer or the like, which is accessible to the Internet. Preferably, each of the first and second user terminals 200 and 300 may be a smart device in which an application program is installed to implement an unidentified recipients message exchange service. The smart device refers to a product whose functions are not limited and can be partially modified or extended through the application program. The smart device may be a smart phone, tablet PC, smart TV or the like. However, the first or second user terminal 200 or 300 of the present invention is not limited to the smart device listed herein. That is, a smart device may sufficiently serve as the first or second user terminal 200 or 300 regardless of the specific type of terminal, as long as it sends a message while connected to the service providing server 100 through a network and receives a message filtered by a filter. If the smart device described above is used as the first or second user terminal 200 or 300, a dedicated application program can be installed in the smart device, and thus it is possible to provide fast and smooth services.

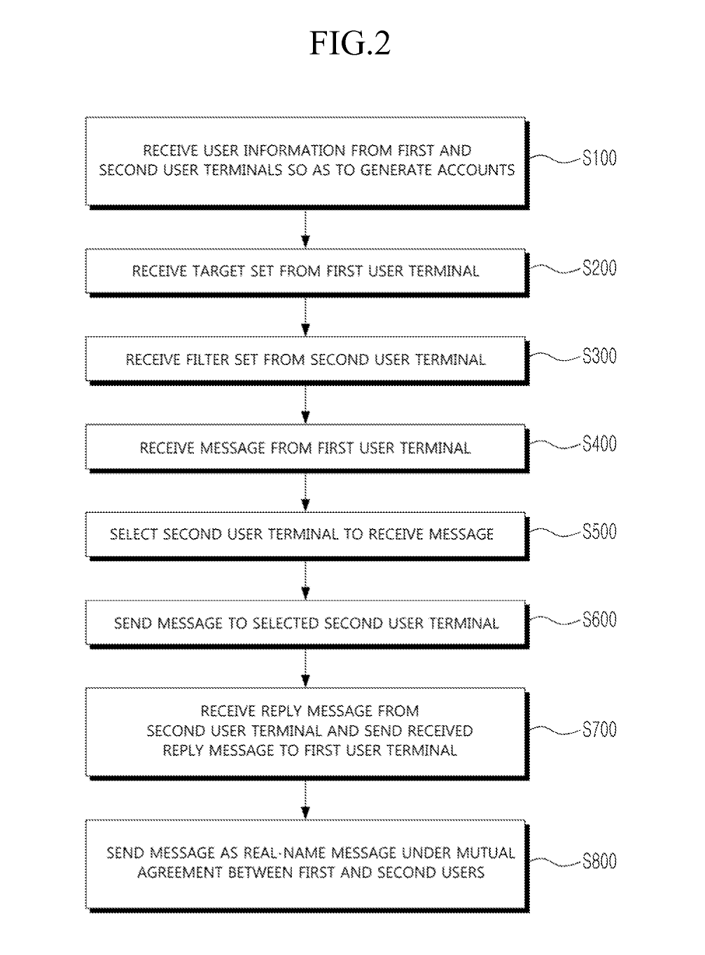

FIG. 2 is a flowchart illustrating the unidentified recipients message exchange service providing method according to an embodiment of the present invention. As shown in FIG. 2, the unidentified recipients message exchange service providing method according to this embodiment may include the steps of: receiving a target set from a first user terminal 200 (S200), receiving a filter set from a second user terminal 300 (S300), receiving a message inputted from the first user terminal 200 (S400), selecting the second user terminal 300 to receive the message (S500), and sending the message to the selected second user terminal 300 (S600). The unidentified recipients message exchange service providing method may further include the steps of: receiving user information from the first and second user terminals 200 and 300 used to generate accounts (S100) by the service providing server 100, receiving a reply message inputted from the second user terminal 300 and sending the received reply message to the first user terminal 200 (S700) and sending the message as an anonymous message under a mutual agreement between first and second users (S800).

At step 100, the service providing server 100 may receive user information from the first and second user terminals 200 and 300 used by the service providing server 100 to generate accounts. The user information may contain a name, an identity (ID), a password, a contact address, a self-introduction, a photograph and the like. The user information may be stored as a profile. The receiving of the user information used to generate the accounts by the service providing server 100 at step 100 is performed to store a variety of setup information for each user and distinguish between individuals. Therefore, the account may be generated by the service providing server 100 not by receiving an ID, and/or a password etc., but by using a phone number, etc. Meanwhile, the received user information may be encrypted for the purpose of protecting personal information, and then stored in the service providing server 100.

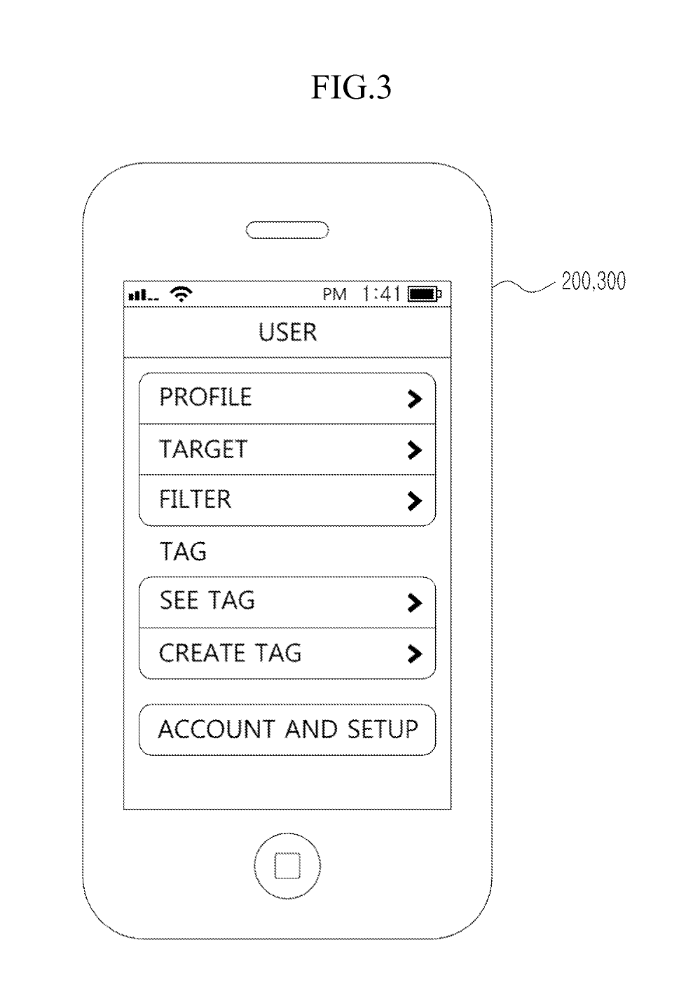

FIG. 3 is a view showing the first or second user terminal 200 or 300 having a setup screen displayed thereon in the unidentified recipients message exchange service providing method according to an embodiment of the present invention. As shown in FIG. 3, in the unidentified recipients message exchange service providing method according to this embodiment, the first or second user terminal 200 or 300 displays a setup screen which allows user information to be inputted through a profile menu. The service providing server 100 receives the inputted user data and generates an account using the received user information.

At step S200, the service providing server 100 may receive a target set from the first user terminal 200. The target allows the first user to characterize the second user to which a message is to be sent. For example, when assuming that the target is ‘Baduk (Korean checkers),’ the service providing server 100 may send a message received from the first user terminal 200 to the second users interested in Baduk at step S600 which will be described in detail later. Step S200 may be performed by receiving a target inputted through a target menu shown in FIG. 3 at the first user terminal 200. The default value of the target may be set to all users so as to maximize audience and help selection of the first user. As the first user sets an additional target such as country or language, the range of second users to receive a message may be narrowed.

At step S300, the service providing server 100 may receive a filter set from the second user terminal 300. The filter may characterize messages of which reception is to be cancelled or allowed by the second user. For example, when assuming that the filter is ‘Baduk,’ including the messages with the target set as Baduk in messages inputted by the first user terminal 200, the service providing server 100 may filter messages related to Baduk and send the filtered messages to the second user terminal 300. Step S300 may be performed by receiving a filter inputted through a filter menu shown in FIG. 3 at the second user terminal 300. The default value of the filter may be set to “none” to allow maximum number of messages so as to help selection of the second user. As the second user sets an additional filter such as country, language, or keywords, messages may be additionally filtered by the filter and received by the second user terminal 300.

Meanwhile, the target or filter may be selected from a tag group containing a plurality of tags. The tag group may contain a public tag defined by the service providing server 100 and a private tag defined by the first user terminal 200. The public tag may contain a general tag, e.g., a hobby such as Baduk or golf, and the private tag may contain ‘xx high school,’ etc. The public and private tags may all be stored and managed in the service providing server 100. The tags are collectively managed, so that it is possible to minimize problems that may be caused by setting different targets or filters for each user.

At step S400, the service providing server 100 may receive a message from the first user terminal 200. The message may contain a message type, an essential content, a selective content and keywords.

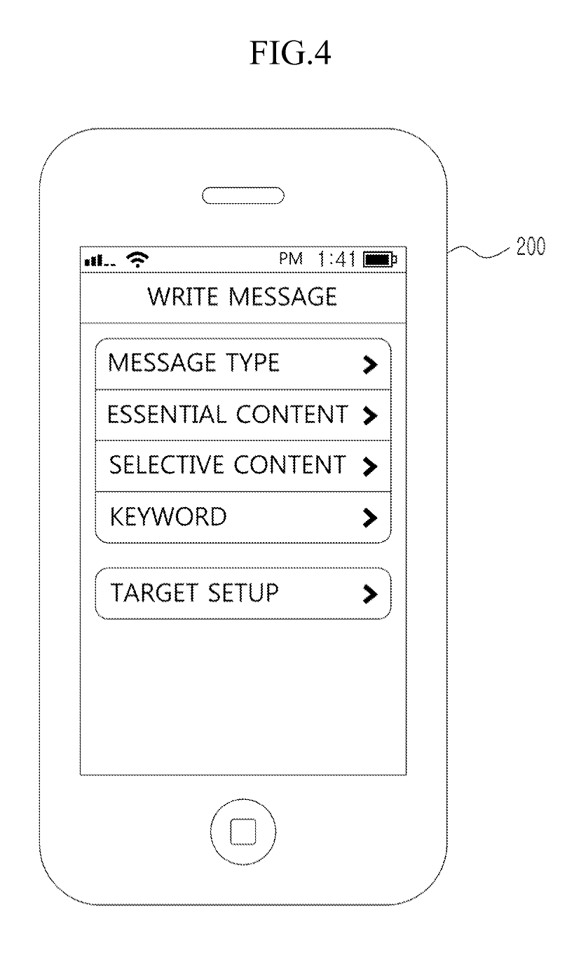

FIG. 4 is a view showing the first user terminal in which a message is inputted at step S400 in the unidentified recipients message exchange service providing method according to an embodiment of the present invention. In the unidentified recipients message exchange service providing method according to this embodiment, step S400 may be performed by selecting and inputting contents which constitute a message, as shown in FIG. 4. However, depending on embodiment, the service providing server 100 may process a message inputted from the first user, so as to extract a message type, an essential content, a selective content, keywords, etc. In the present invention, step S200 may be previously performed so that the target set by the first user is stored in the service providing server 100. However, as shown in FIG. 4, the target may be changed for each message by setting the target when the message is inputted.

At step S500, the service providing server 100 may select the second user terminal 300 to receive the message using contents of the received message, the target received at step S200, and the filter received at step S300. Particularly, at step S500, the contents of the message, used in the selection of the second user terminal 300, may be a message type, keywords, etc., and the service providing server 100 may use information in the filter received from the second user terminal 300, account information, etc.

For example, if the message type is ‘help-wanted advertisement’ and the keyword is ‘home-delivery service,’ the corresponding message may be a message for employing a deliveryman, and the corresponding message may be sent by selecting a terminal of a user who has set the ‘help-wanted advertisement’ as the filter and ‘home-delivery service’ as the keyword as the second user terminal 300.

At step S600, the service providing server 100 may send the message to the selected second user terminal 300. In the unidentified recipients message exchange service providing method according to this embodiment, the service providing server 100 sends the message to the second user terminal 300 selected at step S500. Hence, although a recipient is not specified by the first user terminal 200, the message can be smoothly exchanged, and business information or general information can be exchanged not only with acquaintances but also with many unknown people.

Meanwhile, the unidentified recipients message exchange service providing method according to this embodiment may further include receiving whether or not to send the message as an anonymous message selected by the first user terminal 200 (not shown). That is, since the first user cannot know who the second user to receive the first user's message is, the first user may desire the message to be sent as an anonymous message so as to minimize exposure of personal information. Alternatively, the first user may desire the message to be sent as a real-name message so as to ensure reliability. Thus, when the service providing server 100 receives a selection to send the message as an anonymous message from the first user terminal 200, the service providing server 100 may send the message as the anonymous message to the selected second user terminal 300 at step S600. That is, at step S600, the service providing server 100 may remove all information of the first user from the message and then send the message to the second user terminal 300.

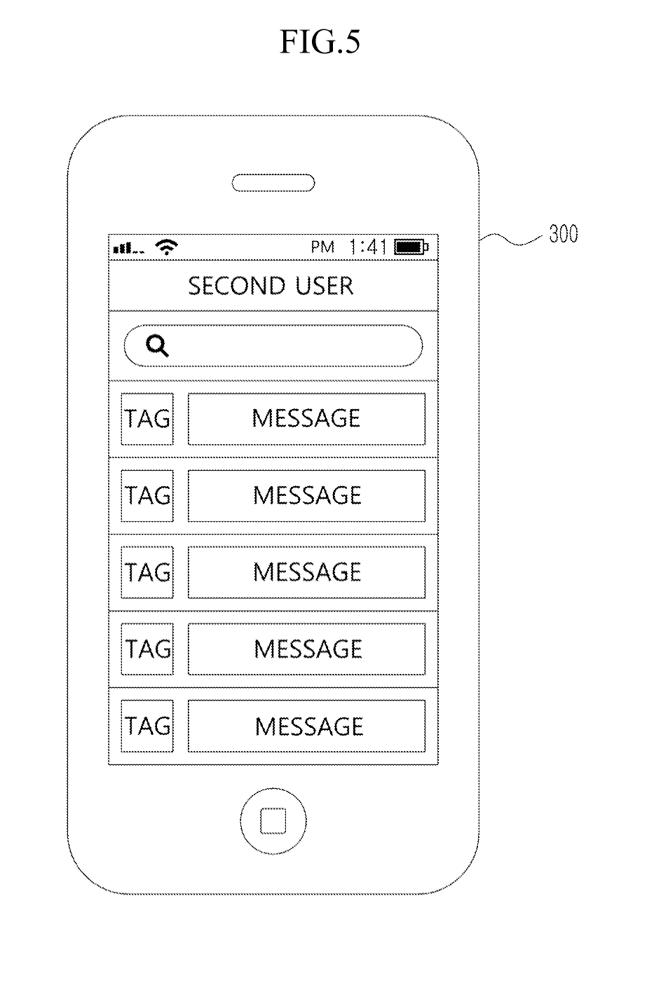

FIG. 5 is a view showing the second user terminal 300 receiving a message sent at step S600 in the unidentified recipients message exchange service providing method according to an embodiment of the present invention. At step S600, the service providing server 100 sends only the tag and content of the message to the second user terminal 300 as shown in FIG. 5, so that the user information of the first user is not exposed. Although the tag or content of the message, shown in FIG. 5, may be touched or clicked, the user information of the first user sending the message is not revealed.

At step S700, the service providing server 100 may receive a reply message from the second user terminal 300 and send the received reply message to the first user terminal 100. For example, the second user may request that the service providing server 100 send the reply message by touching or clicking the content of the message, etc. in the second user terminal 300 shown in FIG. 5. In this case, the reply message may be sent to only the first user terminal 200. If the first user selects that the message is to be sent as an anonymous message, the reply message may be sent as an anonymous message.

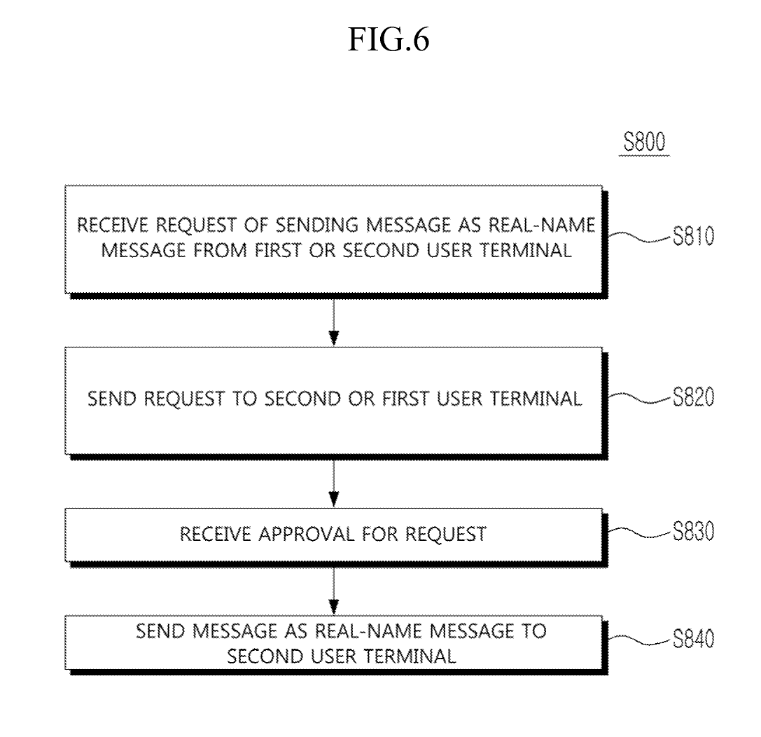

At step S800, the service providing server 100 may send the message as an anonymous message under a mutual agreement between the first and second users. In the present invention, the message may be exchanged as an anonymous message or real-name message. If the message exchange is initially requested from the first user terminal so that the anonymity is secured, the message is exchanged such that anonymity is continuously secured. However, the unidentified recipients message exchange service providing method according to this embodiment further includes step S800, so that each message can be sent as an anonymous message as occasion demands. Hereinafter, a detailed procedure at step 800 will be described in detail with reference to FIG. 6.

FIG. 6 is a flowchart illustrating a detailed procedure at step S800 in the unidentified recipients message exchange service providing method according to an embodiment of the present invention. As shown in FIG. 6, step S800 in the unidentified recipients message exchange service providing method according to this embodiment may include the steps of: receiving a request for sending a message as a real-name message from the first or second user terminal 200 or 300 (S810), sending the request to the first or second user terminal 200 or 300 (S820), receiving an approval for the request from the first or second user terminal 200 or 300 (S830), and sending the message as the real-name message to the second user terminal 300 (S840).

At step S810, the service providing server 100 may receive a request to send a message as a real-name message from the first or second user terminal 200 or 300. In the message exchange process, it may be necessary to expose a real name such as a name or contact address. Thus, at step S810, the service providing server 100 may receive the request to send the message as the real-name message from the first or second user terminal 200 or 300 and request the first or second user terminal 200 or 300 to send personal information.

At step S820, the service providing server 100 may send the request to send the message as the real-name message to the second or first user terminal 300 or 200. That is, if the service providing server 100 receives the request sent from the first user terminal 200 at step S810, the service providing server 100 may send the request to the second user terminal 300. If the service providing server 100 receives the request sent from the second user terminal 300 at step S810, the service providing server 100 may send the request to the first user terminal 200. Since users using the unidentified recipients message exchange service providing method according to this embodiment may greatly value the security of anonymity, a real-name message exchange service is provided only under a mutual agreement between the first and second users. Thus, the first and second users can request each other to send the message as the real-name message at step S820.

At step S830, the service providing server 100 may receive an approval of the request to send the message as a real-name message from the second or first user terminal 300 or 200. At step S830, the service providing server 100 receives approval for the request from the second or first user terminal 300 or 200 receiving the request sent at step S820, thereby obtaining the mutual agreement for real-name message exchange.

At step S840, the service providing server 100 may send the message as the real-name message to the second user terminal 300. That is, at step S840, the service providing server 100 may send the message so as to expose at least one of user information contained in a user's profile, such as a name, an ID, a contact address and a photograph. In this case, the message is sent as the real-name message only between users having the mutual agreement for the real-name message exchange. In a case where the mutual agreement for the real-name message exchange is made at steps S810 to S830, the service providing server 100 may identify whether or not the mutual agreement is to be used only once, so that other messages except the specified message are not sent as real-name message.

As described above, in the unidentified recipients message exchange service providing method according to the present invention, only necessary messages can be received without the sender specifying a recipient by receiving a target, a filter and a message from users and sending the message using contents of the message being sent, the target, and the filter.

Further, the message is sent as an anonymous message, so that it is possible to protect personal information. Furthermore, the message is sent as a real-name message as occasion demands, so that it is possible to support smooth communication through message exchanges.

Although a few embodiments of the present invention have been shown and described, it would be appreciated by those skilled in the art that changes may be made in this embodiment without departing from the principles and spirit of the invention, the scope of which is defined in the claims and their equivalents.

1. An unidentified recipients message exchange service providing method, comprising the steps of: by a service providing server for providing the method,
(1) receiving a target set from a first user terminal;
(2) receiving a filter set from a second user terminal;
(3) receiving a message from the first user terminal;
(4) selecting second user terminals to receive the message using contents of the received message, the target, and the filter; and
(5) sending the message to the selected second user terminals,
wherein the method further comprises a step of receiving whether or not to send the message as an anonymous message, selected from the first user terminal, and when receiving the selection of sending the message as an anonymous message from the first user terminal, the service providing server sends the message as an anonymous message to the selected second user terminals at step (5).

2. The method of claim 1, further comprising a step of (0) receiving user information from the first and second user terminals at the service providing server wherein the user information is used by the service providing server to generate accounts.

3. The method of claim 2, wherein, at step (0), the user information is encrypted and stored.

4. The method of claim 1, wherein the target or filter may be selected from a tag group containing a plurality of tags.

5. The method of claim 4, wherein the tag group contains a public tag defined by the service providing server and a private tag defined by the first user terminal.

6. The method of claim 1, wherein the message contains a message type, an essential content, a selective content, and keywords.

7. The method of claim 1, further comprising a step of (6) receiving a reply message inputted from the second user terminal and sending the received reply message to the first user terminal.

8. The method of claim 1, further comprising a step of (7) sending the message as a real-name message under a mutual agreement between first and second users.

9. The method of claim 8, wherein step (7) comprises the steps of:
receiving a request for the message as the real-name message from the first or second user terminal;
sending the received request to the second or first user terminal;
receiving an approval for the sent request from the second or first user terminal; and
sending the message as the real-name message to the second user terminal.

10. The method of claim 1, wherein each of the first and second user terminals is a smart device in which an application program for implementing the method is installed.
